(19) United States
(12) Patent Application Publication
(10) Pub. No.: US 2004/0216233 A1
(43) Pub. Date: Nov. 4, 2004

(54) Board-type device for supporting a body part of a patient

(76) Inventors: Carmen Ludwig, Gera (DE); Dirk Stolze, Saalfeld (DE)

Correspondence Address: FISH & RICHARDSON PC, 225 FRANKLIN ST, BOSTON, MA, 02110, US

(21) Appl. No.: 10/705,671

(22) Filed: Nov. 12, 2003

(30) Foreign Application Priority Data
Nov. 12, 2002 (DE) 102 53 877.8

(51) Int. Cl. A61G 7/00; A61G 13/00

(52) U.S. Cl. 5/601; 5/722

(57) ABSTRACT

A multi-part carrying structure apparatus for supporting a body part of a patient, includes a main carrying structure having a narrow support surface and a first additional part having a support surface. The first additional part is detachably connected to the main carrying structure. When the first additional part is connected to the main carrying structure, a first combined support surface including the narrow support surface of the main carrying structure and the support surface of the first additional part is wider than the narrow support surface of the main carrying structure. The main part and the first additional part are produced from a material having a high degree of transparency for X-rays.

### CLAIM OF PRIORITY

This application claims priority under 35 USC § 119(a) to German Patent application number No. 102 53 877.8, filed on Nov. 12, 2002, the entire contents of which are hereby incorporated by reference.

### TECHNICAL FIELD

This disclosure relates to a device for supporting a patient, in particular, a board-type device for supporting a body part of a patient.

### BACKGROUND

Devices for supporting a patient form at least part of a patient bench or an operating table and are used in a variety of forms. With their aid, a patient can be reliably supported on the supporting surface for carrying out therapeutic treatments and surgical interventions as well as for methods of diagnosis, in particular, for examinations by computer tomography (CT) or by magnetic resonance tomography (MRT).

To ensure stable support of the patient, it is desirable for the supporting surface to have a certain minimum width. On the other hand, however, when transilluminating a patient in a computer tomograph, the supporting surface must be introduced into the imaging system of the tomograph (i.e., between the X-ray tube and the sensors lying opposite the X-ray tube). Thus, when transilluminating the patient at an oblique angle in relation to the longitudinal axis of the body of the patient, the problem arises that the maximum angle at which transillumination can be performed obliquely to the longitudinal axis of the patient is restricted by the width of the supporting surface.

### SUMMARY

A board-type device ensures stable patient support and enables transillumination of the patient at a large oblique angle in relation to the longitudinal axis of the patient's body. This is accomplished by having a board-type device with a main part and at least one additional part that can be detachably coupled to the main part.

In a first general aspect, a multi-part carrying structure apparatus for supporting a body part of a patient, includes a main carrying structure having a narrow support surface and a first additional part having a support surface. The first additional part is detachably connected to the main carrying structure. When the first additional part is connected to the main carrying structure, a first combined support surface including the narrow support surface of the main carrying structure and the support surface of the first additional part is wider than the narrow support surface of the main carrying structure. The main part and the first additional part are produced from a material having a high degree of transparency for X-rays.

The multi-part carrying structure can include one or more of the following features. The apparatus can further include a coupling element for connecting the main part to the first additional part. The main part and the first additional part can be configured in board form. The apparatus can further include a second additional part that is detachably connected to a second lateral side of the main carrying structure, where, when the second additional part is connected to the main carrying structure, a second combined support surface including the narrow support surface of the main carrying structure and a support surface of the second additional part is wider than the narrow support surface of the main carrying structure, where the first additional part is detachably connected to a first lateral side of the main carrying structure, and where the main part and the first additional part are produced from a material having a high degree of transparency for X-rays.

The first additional part and the second additional part can be configured in a mirror-inverted manner in relation to each other. The main part can extend over an entire length of the carrying structure. The main part can be configured in the form of a T. The main part can be configured in the form of a Y. The main part and the first additional part can be produced from a carbon-fiber material. The main part and the first additional part can be formed as solid boards. The main part and the first additional part can have a trapezoidal cross-section.

The coupling element can be produced from a carbon-fiber material. The coupling element can include a connecting element that is movably mounted on the main part and can be introduced into a receptacle within the first additional part. The coupling element can include a connecting element that is movably mounted on the first additional part and can be introduced into a receptacle within the main part. The coupling element can be configured as a cross member that is displaceably mounted transversely in relation to the longitudinal axis of the main part. The coupling element can be configured as a cross member that is displaceably mounted transversely in relation to the longitudinal axis of the main part. The connecting element can be displaceably mounted in a guide that is fixed on the additional part and can be introduced into a receptacle of the main part.

The apparatus can further include a table-top segment of a patient supporting table to which the main part can be coupled.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic side view of an operating table with a board-type device for supporting a body part of a patient.

FIG. 2A is a schematic plan view of the operating table represented in FIG. 1 with an additional part detached from the main part of the board-type device and with the main part configured as a “Y.”

FIG. 2B is a schematic plan view of the operating table represented in FIG. 1 with an additional part detached from the main part of the board-type device and with the main part configured as a “T.”

FIG. 3 is an exploded representation of the board-type device.

Like reference symbols in the various drawings indicate like elements.

### DETAILED DESCRIPTION

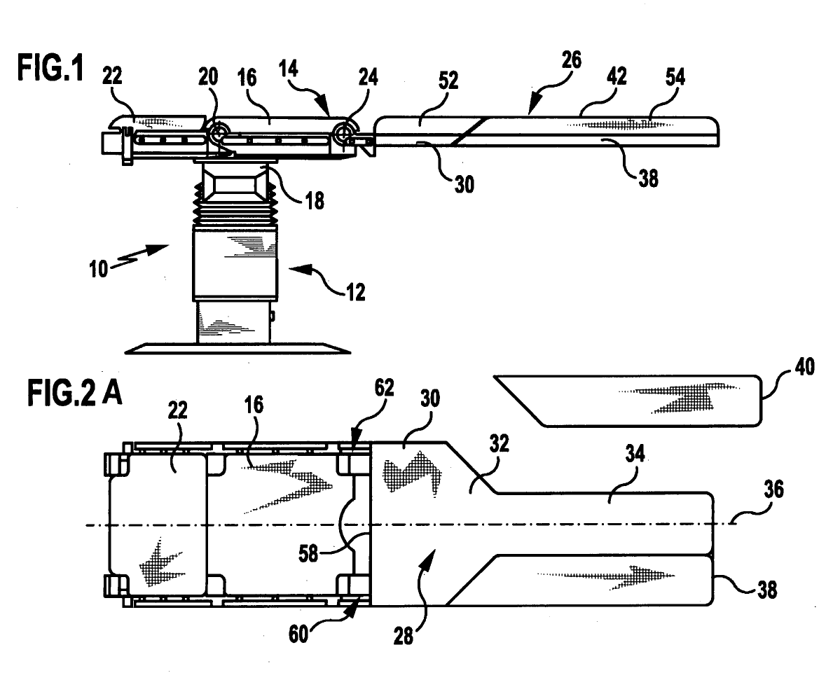

Referring to FIG. 1, an operating table is designated overall by reference numeral 10, and has a supporting column 12 and a table top 14 that can be detachably connected to the supporting column 12. The table top 14 is configured in a multi-part manner and includes a base segment 16 that can be detachably connected to a supporting column head 18 of the supporting column 12. Pivotably mounted on the base segment 16 are a first end segment 22, pivotable about a horizontal pivoting axis 20, and a second end segment 26, pivotable about a likewise horizontally aligned pivoting axis 24. The second end segment 26 is formed by a board-type device for supporting a body part of a patient, the head and torso region of whom can for example be supported by the second end segment 26 and the leg and foot region of whom can be supported by the base segment 16 and the first end segment 22. The patient can also be supported in a converse manner, such that the head and torso region of the patient is supported by the first end segment 22 and the base segment 16, respectively, while the leg and foot region of the patient is supported by the second end segment 26.

The board-type device in the form of the second end segment 26 defines on its upper side a supporting surface 42 for a patient. The second end segment 26 includes a main part 28 that extends over the entire length of the second end segment 26, is configured substantially in the form of a Y and has a transverse portion 30 that extends over the entire width of the table top 14 and is adjoined by a longitudinal portion 34 via a cross-sectionally narrowing intermediate portion 32. The second end segment 26 also has two additional parts 38 and 40 that are configured mirror-symmetrically in relation to the longitudinal axis 36 of the body of a patient to be supported on the table top 14, are laterally adjacent to the main part 28 in the region of the intermediate portion 32 and the longitudinal portion 34, and are detachably connected to the main part 28.

For this purpose, fixed on the undersides of the additional parts 38 and 40 that are remote from the supporting surface 42, there are in each case two guide sleeves 44, which are disposed at the level of the transitional region between the intermediate portion 32 and the longitudinal portion 34, and also at the level of the free end of the longitudinal portion 34 and in each case receive a connecting element in the form of a bolt 46, which is displaceable transversely in relation to the longitudinal axis 36 of the body and has associated with it, on the side edge 48 of the longitudinal portion 34 of the main part 28 that is facing the respective additional part 38 or 40, a receptacle 50, into which it can be introduced to establish a detachable connection between the additional part 38 or 40 on the one hand and the main part 28 on the other hand. On their upper side, the main part 28 and the two additional parts 38 and 40 in each case carry a cushioning segment 52, 54 and 56, respectively.

To establish a detachable connection between the second end segment 26 and the base segment 16 of the table top 14, two coupling parts 60, 62 (that are known and therefore represented only schematically in the drawing) are fixed on the end face 58 of the transverse portion 30 that is remote from the longitudinal portion 34.

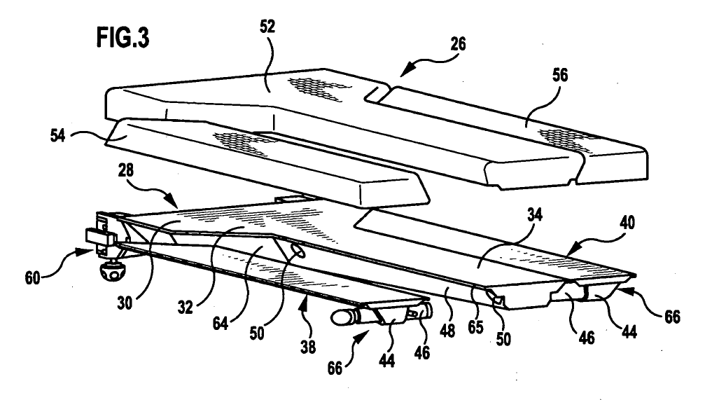

The main part 28 and the two additional parts 38 and 40 are formed, e.g., from a carbon-fiber material, in the form of boards that can be formed in a solid manner. They receive the weight of the body part of the patient supported on them, without an additional supporting structure having to be used. In cross-section, the two additional parts 38 and 40 are configured just like the longitudinal portion 34 of the main part 28 in a trapezoidal form, which is clear from FIG. 3. The longitudinal portion 34 has in this case a cross-sectional form in the form of a symmetrical trapezoid, the side edge 48 of the longitudinal portion 34 that is respectively facing an additional part 38 or 40 being inclined downward obliquely in relation to the vertical in just the same way as the side edge 64 of the intermediate portion 32 that is adjoining it, and the additional parts 38 and 40 engage under a lip 65 of the main part 28 that is projecting beyond the side edges 48 and 64, in the region of the intermediate portion 32 and the longitudinal portion 34 of said main part.

The guide sleeves 44 and the bolts 46, which in their combination respectively form a coupling element 66 to establish a detachable connection between an additional part 38 or 40 and the main part 28, are produced, e.g., from a carbon-fiber material, so that the second end segment 26 has a very high level of transparency for X-radiation with the exception of the two coupling parts 60 and 62. In order to ensure this, the cushioning elements 52, 54, and 56 are also produced from a radiotransparent material.

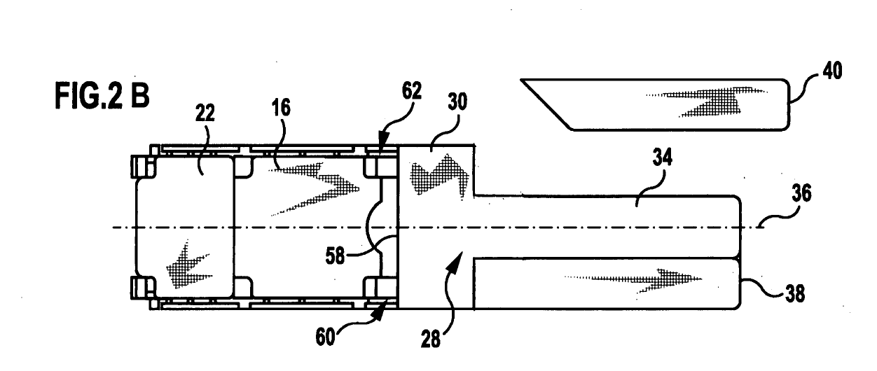

The 3-part configuration of the second end segment 26 in the form of the main part 28 and the two additional parts 38 and 40 makes it possible to make the supporting surface 42 of the second end segment 26 narrower in an easy way, in that at least one additional part 38 or 40 is removed from the main part 28. This is schematically represented in FIG. 2. As a result, a free space is created in the lateral border region of the main part 28 at the level of its longitudinal portion 34, in which space an X-ray tube or the detectors associated with it can be positioned for transilluminating a patient at an angle of up to 45 degrees to the longitudinal axis 36 of the body of said patient.

The 3-part configuration of the second end segment 26 transversely in relation to the longitudinal axis 36 of the body consequently allows the suitability of the table top 14 for use for the transillumination of a patient to be enhanced considerably. Depending on the side on which the supporting surface 42 is to be made narrower, with reference to the longitudinal axis 36 of the patient's body, the left-hand or right-hand additional part can be removed from the main part 28. It is also possible to remove both additional parts 38, 40 at the same time in order to achieve a particularly narrow supporting surface 42.

The main part 28 can extend over the entire length of the carrying structure. The main part 28 consequently forms a central portion of the carrying structure that can be configured in a particularly solid manner and can bear the full weight of the patient. The additional parts 38, 40, which extend at least over a subregion of the entire length of the carrying structure can be used according to choice and can then be used to supplement the main part 28, or else can be removed for better accessibility of the imaging system of the computer tomograph when transilluminating a patient. Further carrying elements (not shown) can be coupled to the main part 28, for example, for supporting the extremities or the head of the patient.

Using the above-described carrying structure configuration, a radiotrasparent device for supporting a patient can be made, in that not only the main part 28, but also the additional parts 38, 40, and the at least one coupling element 66 are produced from a material of high transparency for X-radiation. This makes it possible, in particular, to produce high-quality computer tomography scans even in the region of the coupling elements 66. If a CT scan is to be produced perpendicularly in relation to the longitudinal axis 36 of the patient's body, the additional part 38, 40 can be connected to the main part 28 and, as a result, the carrying structure can form a wide supporting surface 42 for the patient. However, the patient sometimes is to be transilluminated obliquely in relation to the longitudinal axis 36 of said patient's body, for example, in the shoulder region or hip region. In such a transillumination, an X-ray tube is used and the sensors of the computer tomograph that are lying opposite it are aligned obliquely in relation to the longitudinal axis 36 of the body, while maintaining a constant distance between the X-ray tube and the sensors. When performing such a transillumination, the supporting surface 42 can be made narrower in a simple way, in that the additional parts 38, 40 of the carrying structure can be removed from the main part 28. Hindering of the computer tomograph by the carrying structure when transilluminating the patient obliquely in relation to the longitudinal axis of said patient's body is therefore reliably avoided.

The main part 28 and/or additional parts 38, 40 can be configured in board form, which make it possible to produce the device at a low cost, but ensuring that the carrying structure adequately bears the weight of the patient without the need to form additional supporting elements. The main part 28 can be configured in the form of a T or Y, such that the main part 28 narrows along the direction of the longitudinal axis 36 of the patient's body. It has been found that the mechanical load-bearing capacity of the carrying structure can be improved as a result. The main part 28 and/or the additional parts 38, 40 are configured trapezoidally in cross-section, at least in certain regions. When two additional parts 38, 40 are used, respectively abutting against the longitudinal side of the main part, the main part 28 can have in its region disposed between the two additional parts 38, 40 a cross-section in the form of a symmetrical trapezoid.

The additional parts 38, 40 engage under the main part 28. It has been found that the load-bearing capacity of the carrying structure in the border region between the main part and an additional part can be improved as a result. So it may be provided, for example, that the main part 28 and the additional parts 38, 40 have in the respective abutting region mutually facing side faces aligned obliquely in relation to the vertical.

To provide the carrying structure with particularly good transparency to X-rays, the main part 28 and/or the additional parts 38, 40 can be produced from a carbon-fiber material. Such materials are distinguished by very high transparency to X-rays. They also have the advantage that they have only a low specific weight. They are therefore particularly suitable for forming the removable additional parts 38, 40, because, with low weight, their handling is made especially easy. Carbon-fiber material is understood here as meaning carbon-fiber-reinforced plastics.

Particularly easy handling of the device when removing an additional part 38, 40 and when connecting the additional part 38, 40 to the main part 28 can be achieved by a coupling element 66 having a connecting element 46 that is movably mounted on the main part 28 or on one of the additional part 38, 40 and can be introduced into a receptacle 50 of the additional part 38, 40 or of the main part 28, respectively. With the connecting element 46, a connection that can be mechanically loaded can be established between the main part 28 and the additional part 38, 40. The connecting element 46 allows the force of the weight exerted by the patient on the additional part 38, 40 to be transferred to the main part 28. The connecting element 46 may be configured for example in the form of a cross member, which is displaceably mounted transversely in relation to the longitudinal axis 36 of the patient's body.

Particularly easy handling when removing the additional part 38, 40 from the main part 28 can be achieved by the connecting element 46 being displaceably mounted in a guide 44 that is fixed on the additional part 38, 40 and can be introduced into a receptacle 50 of the main part 28. For removal, it is then merely required for the connecting element 46 to be brought out of the receptacle 50 of the main part 28, so that the additional part 38, 40 can subsequently be removed from the main part 28. Conversely, when coupling the additional part 38, 40 onto the main part 28, it is merely required for the connecting element 46 mounted on the additional part 38, 40 to be introduced into the receptacle 50 of the main part 28.

The connecting element 46 can be locked in the receptacle 50, allowing unintentional detachment of the additional part 38, 40 from the main part 28 to be reliably avoided.

The board-type device can form the table top of a patient supporting table. It can, however, also be provided that the board-type device can be coupled to a table-top segment of a patient supporting table, for example to a central table-top segment of a patient bench or of an operating table.

### OTHER EMBODIMENTS

A number of embodiments of the invention have been described. Nevertheless, it will be understood that various modifications may be made. Accordingly, other embodiments are within the scope of the following claims.

What is claimed is:

1. A multi-part carrying structure apparatus for supporting a body part of a patient, the apparatus comprising:
a main carrying structure having a narrow support surface;
a first additional part having a support surface, the first additional part being detachably connected to the main carrying structure, wherein when the first additional part is connected to the main carrying structure a first combined support surface including the narrow support surface of the main carrying structure and the support surface of the first additional part is wider than the narrow support surface of the main carrying structure; and
wherein the main part and the first additional part are produced from a material having a high degree of transparency for X-rays.

2. The apparatus of claim 1, further comprising a coupling element for connecting the main part to the first additional part.

3. The apparatus of claim 1, wherein the main part and the first additional part are configured in board form.

4. The apparatus of claim 1, further comprising a second additional part, the second additional part being detachably connected to a second lateral side of the main carrying structure, wherein when the second additional part is connected to the main carrying structure a second combined support surface including the narrow support surface of the main carrying structure and a support surface of the second additional part is wider than the narrow support surface of the main carrying structure;
wherein the first additional part is detachably connected to a first lateral side of the main carrying structure; and
wherein the main part and the first additional part are produced from a material having a high degree of transparency for X-rays.

5. The apparatus of claim 4, wherein the first additional part and the second additional part are configured in a mirror-inverted manner in relation to each other.

6. The apparatus of claim 1, wherein the main part extends over an entire length of the carrying structure.

7. The apparatus of claim 1, wherein the main part is configured in the form of a T.

8. The apparatus of claim 1, wherein the main part is configured in the form of a Y.

9. The apparatus of claim 1, wherein the main part and the first additional part are produced from a carbon-fiber material.

10. The apparatus of claim 9, wherein the main part and the first additional part are formed as solid boards.

11. The apparatus of claim 10, wherein the main part and the first additional part have a trapezoidal cross-section.

12. The apparatus of claim 2, wherein the coupling element is produced from a carbon-fiber material.

13. The apparatus of claim 2, wherein the coupling element includes a connecting element that is movably mounted on the main part and can be introduced into a receptacle within the first additional part.

14. The apparatus of claim 2, wherein the coupling element includes a connecting element that is movably mounted on the first additional part and can be introduced into a receptacle within the main part.

15. The apparatus of claim 13, wherein the coupling element is configured as a cross member that is displaceably mounted transversely in relation to the longitudinal axis of the main part.

16. The apparatus of claim 14, wherein the coupling element is configured as a cross member that is displaceably mounted transversely in relation to the longitudinal axis of the main part.

17. The apparatus of claim 14, wherein the connecting element is displaceably mounted in a guide that is fixed on the additional part and can be introduced into a receptacle of the main part.

18. The apparatus of claim 1, further comprising a table-top segment of a patient supporting table to which the main part can be coupled.
